(19) United States
(12) Patent Application Publication
(10) Pub. No.: US 2003/0067545 A1
(43) Pub. Date: Apr. 10, 2003

(54) Device and method for acquiring an image of a portion of the human body

(75) Inventors: Franck Giron, Ferrieres-en-Brie (FR); Johan Aubert, Paris (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: L'OREAL, Paris (FR)

(21) Appl. No.: 10/229,356

(22) Filed: Aug. 28, 2002

(30) Foreign Application Priority Data
Aug. 29, 2001 (FR) 01 11215

(51) Int. Cl. H04N 7/18

(52) U.S. Cl. 348/223.1; 348/77

(57) ABSTRACT

A device and a method for acquiring an image of a portion of the human body, which includes any body part, the face, the skin or the hair of an individual. The device includes an enclosure with an opening sufficiently large for receiving the portion of the human body. The enclosure can be spherical. The device can also include at least one light source to illuminate the enclosure. The device can further include a calibration device which can be colorimetric or spectral. The device can also include a camera and a positioning device to properly position the portion of the human body for the image acquisition.

### CROSS-REFERENCE TO RELATED APPLICATIONS:

This document claims priority to French Application No. 0111215 filed Aug. 29, 2001, the entire content of which is hereby incorporated by reference.

### BACKGROUND OF THE INVENTION

1. Field of the Invention

The present invention relates to devices and methods for acquiring images of a portion of the human body.

2. Description of the Background

Devices for photographing articles are known. For example, the publication Illumination and source engineering, SPIE Proceedings, Volume 3428, 1998, discloses a device including an integrating sphere having powerful lamps fixed thereto. At the front, the sphere has an opening into which the articles to be photographed can be inserted. Fans are fixed to the sphere to dissipate the heat generated by the lamps. Such a device, however, is relatively expensive. It is believed that this device has not been used for acquiring an image of a portion of the human body placed in the opening of the sphere.

U.S. Pat. No. 4,911,544 discloses a system for observing the face of a person. The images acquired with such a system, however, do not include precise color analysis information. Furthermore, such a system does not record an image that can be effectively compared to another image so as to determine the evolution between the two images, for example, showing an alteration in make-up, or used in a treatment for detecting the defects on a face, such as wrinkles and spots.

### SUMMARY OF THE INVENTION

Accordingly, there exists a need for a relatively inexpensive system for reproducibly acquiring a calibrated image of portions of the human body. In this document, the expression “portion of the human body” includes any human body part, the face, the skin, the hair, and portions thereof. In particular, there exists a need for a system for evaluating the skin (for example its relief or its uniformity), the lips, eyelashes, eyebrows, and the hair before and/or after applying a cosmetic or care product on these portions of the human body.

The invention satisfies this need with a device for acquiring at least one image of at least a portion of the human body. The device includes an enclosure provided with an opening that is large enough to receive the portion of the human body to be imaged. The device also includes at least one light source configured to light the enclosure. In a preferred embodiment, the device also includes a calibration device. The calibration device can be, for example, of calorimetric or spectral type.

The calibration device allows the acquisition of at least one calibrated image, which can be used to precisely know the color or spectral reflectance of the portion of the human body. The image calibration facilitates the detection of color variation on the image. Accordingly, it is possible for example to precisely evaluate the homogeneity of the skin color, to perform a treatment for localizing the skin or hair defects, to evaluate shadows or circles under the eyes, or to provide information regarding the collagen or the melanin.

The invention can also be used to evaluate the appearance of a make-up, the coverage of a product and its lasting properties. The invention can also be useful to evaluate the homogeneity and relief of the skin, to evaluate a make-up, a hair property, for example, its color or the lasting effect of a hairspray. The invention can also be useful to determine the UV absorption of a sunscreen.

The calibration device of the present invention allows the acquisition of calorimetric coordinates at a point of the image. These calorimetric coordinates can be part of a reference colorimetric space, such as, for example, the space according to the CIE 1976 CIELAB system. The calibration device permits the measurement at different points of the image, or between two images, of the differences in color, shade and clarity. This data can be useful to detect defects in the face, for example. The invention permits the detection of relatively weak or small color differences, and therefore allows one to precisely define the contour of the defects.

The invention also provides trichromatic coordinates other than R (red), G (green), and B (black). The calibration device can include, for example, at least five surfaces representing different optical properties. At least three surfaces can correspond to different gray levels and at least two can correspond to different shades.

The calibration device can be coupled to the enclosure only during the calibration stage. In a preferred embodiment, the calibration system can be placed in the opening of the enclosure prior to the acquisition of the images.

Alternatively, the calibration system can be fixed permanently to the enclosure. In another embodiment, the calibration system can be fixed to the skin, for example, on the middle of the forehead during the acquisition of the image. Advantageously, the acquisition system can include a positioning device for the face of the individual and/or a fixation device for the calibration system.

The positioning device permits the person who is to be filmed or photographed to retain substantially the same pose throughout image acquisition. The positioning device can thus facilitate the acquisition of images in a reproducible manner, which can be advantageous when the person's appearance is compared before and after a treatment with a care product or an application of a makeup.

In a particular embodiment, the positioning device includes a support configured to support at least a portion of the face. The support may be adapted to provide a chin rest, and to removably mount the calibration device.

In a particular embodiment, the positioning device includes a mirror placed inside the enclosure and positioned so as to reflect an image of the portion of the human body to be imaged. The mirror can be positioned so that it reflects the image toward the opening. Accordingly, when the portion of the human body to be imaged is an individual's face, the mirror enables the individual to see her face when it is placed in the opening. The enclosure can include a sphere and the mirror can be placed above a rear zone diametrically opposite the opening. The mirror can have a reflecting surface which is not planar so as to enlarge details; or alternatively, so as to provide an enlarged field of view.

The positioning device can include at least two light emitters configured to generate crossed light beams. The point of convergence of the crossed light beams can be in a plane where a predetermined portion of the portion of the human body to be imaged is positioned. When the portion of the human body to be imaged is the face, the light emitters can be arranged so that the cross light beams converge on the individual's forehead, i.e., each light emitter projects a light spot on the individual's forehead. In this embodiment, the individual whose head is in the opening of the enclosure can see the spots in the mirror and can correct her position so as to cause the spots to coincide, if needed.

The positioning device can also include an optical, ultrasound, or infrared telemetry device sensitive to the distance between a predefined portion of the human body to be imaged and a reference point of known position relative to the enclosure. The positioning device can include at least one audible sound indicator, or a visible light indicator, which can be heard or seen from inside the enclosure so as to warn the individual when positioning is correct or when it needs to be modified.

The acquisition device can include a video camera. Here, the term “video camera” includes a device configured to acquire images on a continuous, semi-continuous or frame by frame manner. The term “video camera” includes conventional video cameras, allowing acquisition of images with visible light, infrared or ultraviolet, spectral or spectra-radiometric cameras, and digital still cameras.

In a preferred embodiment, the field of view of the camera includes at least a portion of the opening. The camera can observe the portion of the human body placed in the opening from a direction which is substantially parallel to an axis of the opening. An axis of the opening is a line normal to the plane defined by the opening and passing through a symmetry center of the opening. If the opening is circular, the axis of the opening is the line normal to the disk defined by the opening and passing through the center of the disk.

The acquisition device can include at least two video cameras. For example, the cameras can be configured so that one observes the portion of the human body placed in the opening from a direction substantially parallel to the axis of the opening, and the other camera from a direction which makes an angle with the axis of the opening.

In a preferred embodiment, the acquisition device includes three cameras; a front camera for observing the face of the individual substantially on the axis of the opening, plus two lateral cameras disposed substantially symmetrically on either side of a midplane containing the axis of the opening. Each of the lateral cameras can observe the individual's face on a direction that makes an angle with the axis of the opening. The acquisition device can also include at least two cameras configured to acquire relief image.

In a particular embodiment, the calibration device includes a support carrying at least two calorimetric standards, so as to hold each of them in the field of a camera. For example, the support can carry three colorimetric standards associated with all three above-mentioned cameras.

In a particular embodiment, the calibration device includes two lateral colorimetric standards fixed on a support configured to modify their orientations relative to the axis of the opening of the enclosure. Slideways can be configured to hold these two calorimetric standards in position and can be configured to move the colorimetric standards toward or away from respective cameras in the fields of which they are placed. The calibration device can also include a front colorimetric standard.

Each calorimetric standard can have at least twelve colored surfaces, which can be used as references. A calibration can be performed using a method similar to the one described in application WO 97/44642.

As mentioned above, the enclosure is preferably in the form of a sphere. Other shapes, however, can be used to light the portion of the human body to be imaged in a relatively homogeneous fashion. For example, the enclosure can also include at least a portion of its interior surface which is cylindrical with a circular cross-section and a vertical axis. The enclosure can have an interior surface of another geometrical shape. The enclosure can also include at least one panel, which can be planar or slightly concave toward the interior of the enclosure. The enclosure can also include at least two lateral panels, which can be planar and parallel to each other or which can form an angle with each other. Depending on the angle between the two panels, the opening of the enclosure can be varied.

The enclosure can be made of a thermoformed material, for example plexiglass, coated on the inside in white paint, for example a paint based on titanium oxide. An enclosure with sufficient optical properties can thus be manufactured at a relatively low cost.

As mentioned above, the enclosure can include at least one light source. While the singular of “light source” is used in the following discussion, it is to be understood that a plurality of light sources of similar types can be used. The light source can be continuous or pulsed. For example, the light source can be a flash lamp which can be polarized, or the light source can be a xenon lamp.

The light source can include optical fibers configured to carry light from a remote lamp to the integration enclosure. Such an embodiment can be advantageous because the lamp need not be fixed to the enclosure, i.e., it can be remotely positioned, so that a cooling system (e.g., fans) is not needed to reduce the heat generated by the lamp. This embodiment also eliminates the need to bring electrical conductors carrying high voltage to the enclosure, thereby further improving safety for personnel making measurements and for the individuals being imaged.

In a particular embodiment, the light from the optical fibers illuminates the inside surface of the enclosure directly. In this embodiment, the enclosure does not need to have a diffusion screen placed in front of the light source, inside the enclosure. Accordingly, this embodiment reduces the number of component parts and simplifies the manufacturing of the acquisition device.

In a preferred embodiment, at least one light source is steerable so as to be able, if necessary, to illuminate directly the portion of the human body placed in the opening of the enclosure. Direct illumination allows observation of a brilliance effect. Specifically, the optical fibers can be received in swivel-mounted end pieces so that the direction of the light emission into the enclosure can be changed as desired, for example by casting light forwards or rearwards. In a particular embodiment, the angle divergence of the light beam emitted by the fibers can lie in the range 10° to 20°, preferably close to 15°.

The acquisition device can include a support structure configured to support the enclosure. For a spherical enclosure, the support structure can support the enclosure along the equator of the enclosure. In the absence of any cooling fans or lamps fixed to the enclosure, the enclosure can be relatively lightweight and the support structure need not be particularly strong.

An object of the invention is also to provide the above-defined calibration device itself. Another object of the invention is to provide a method of acquiring at least one image of at least a portion of the human body by using an acquisition device including an enclosure having an opening and at least a light source placed inside the enclosure, with the opening sufficiently large to receive the portion of the human body. The method includes a step of calibrating at least one camera, preferably several cameras, by placing a calorimetric or spectral calibration device in the fields of view of the cameras. The calibration device preferably includes a plurality of colorimetric standards. The method also includes a step of acquiring with the camera at least one image of a portion of the human body placed in the opening of the enclosure.

The method can include withdrawing the calibration device before the acquisition of the image. The calibration device can be held by the person being imaged. In another embodiment, the calibration device can be left in place during the acquisition of the image. In another embodiment, the method can include the step of generating trichromatic components of at least one image point in a colorimetric space other than R, G, B. These trichromatic components can be useful to measure color, brilliance, color variations, and/or reflectance. In a preferred embodiment, the method includes illuminating light of a first spectral band and acquiring with the camera light in a second spectral band different from the first. This embodiment allows observation of fluorescence, for example. Such fluorescence can be due to the presence of pigments or of fluorescent colorant in a cosmetic composition or to the presence of a given compound on the skin surface. In another embodiment of the invention, a treatment of the image can be performed so as to detect skin defects. For example, a skin defect can be identified by a color variation on the image.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a fragmentary and diagrammatic view in perspective of a sphere in accordance with the invention;

FIG. 2 is a fragmentary and diagrammatic view of the rear of the inside of the FIG. 1 sphere;

FIG. 3 shows a person positioning her face in the opening of the sphere;

FIG. 4 is a view analogous to FIG. 3 showing the face when properly positioned;

FIG. 5 is a diagrammatic axial section of a fixing endpiece for fixing an optical fiber to the sphere;

FIG. 6 is a fragmentary view of the inside of the sphere showing the positions of the fiber-fixing endpieces;

FIG. 7 is a diagram showing a calibration triptych in place in the sphere; and

FIG. 8 is a diagrammatic perspective view showing the FIG. 7 triptych in isolation.

FIG. 9 is a diagrammatic representation of a calibration device according to another embodiment of the present invention.

FIG. 10 illustrates the placement of a calibration device on the face of an individual.

FIGS. 11 and 12 illustrate other embodiments for the enclosure of the present invention.

### DETAILED DESCRIPTION OF THE PREFERRED EMBODIMENTS

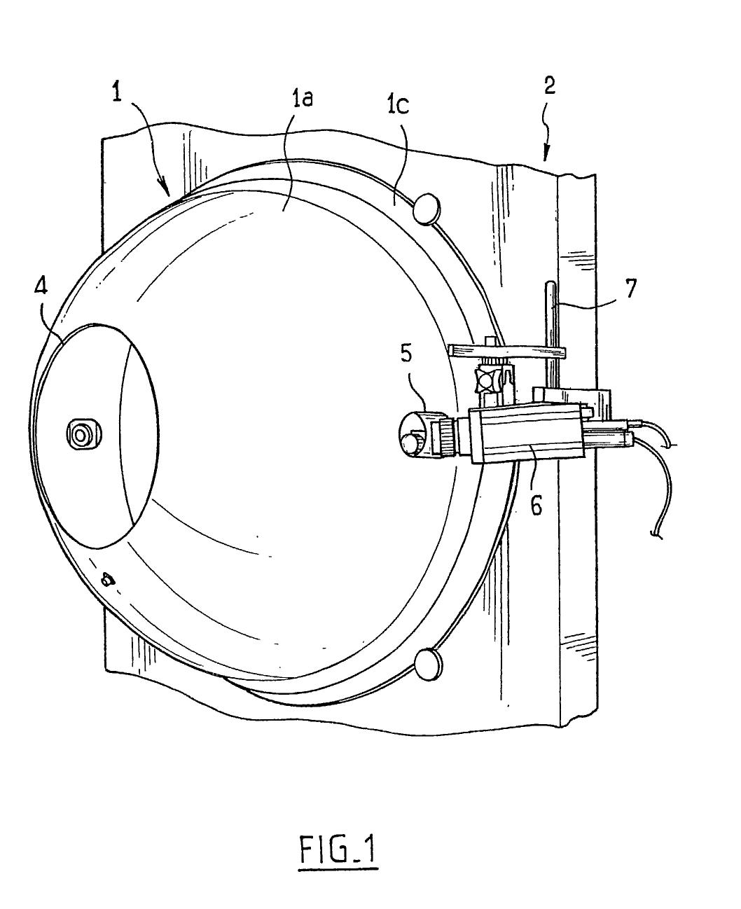

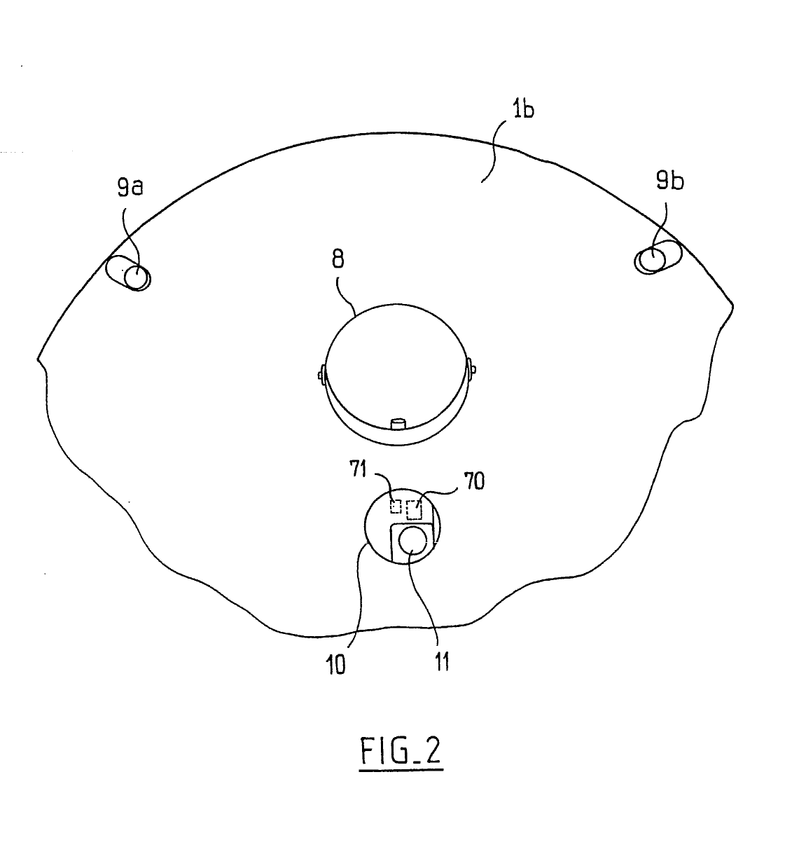

FIG. 1 shows an integration enclosure 1 in accordance with the invention supported by a support structure 2. The enclosure 1 has, in this example, a spherical shape composed of two hemispheres 1a and 1b (shown in FIG. 2) assembled together. The front hemisphere 1a can have a flange 1c configured to fix the hemisphere 1a to the support structure 2, while the back hemisphere 1b can be engaged in and fixed to the front hemisphere. The front hemisphere 1a can be removable. When the front hemisphere 1a is removed, it is possible to take a picture while lighting the individual with the rear hemisphere 1b. The diameter of the sphere 1 can be close to 1 meter (m), for example.

In the example illustrated, each hemisphere 1a or 1b can be made by thermoforming a thermoplastic material, for example plexiglass, using a metal plate having a circular opening with a diameter which corresponds to that of the hemisphere which is to be made. The plate of thermoplastic material is pressed against one face of a metal support and heated. Suction is then established beside the other face of the support so as to suck the plate through the circular opening and form a hemispherical cavity. The hemispheres made with such a method are not perfectly spherical, but are sufficiently spherical for the intended application.

Each hemisphere 1a or 1b can be subsequently coated on its inside surface. For example, they can be painted white. The paint can be opaque, mat, and white, similar to the paint used to paint stratospheric balloons. The paint can be based on titanium oxide and polyurethane, such as the paint sold under the name Skymap 32. In a particular embodiment, the reflectivity of the inside surface of each hemisphere can be close to 1 at wavelengths which are useful for taking pictures. Other embodiments of the invention include other paints, such as paints based on barium sulfate, in particular the paints sold under the name Spectralon, or paints based on zinc orthotitanate coated in silicone or zinc oxide and silicone.

The front hemisphere 1a can be provided with a front opening 4, in which the portion of the human body to be imaged can be placed. For example, an individual can pass her face through the opening 4, as further explained below. In the embodiment illustrated, the opening 4 is circular and its diameter is close to 40 centimeters (cm). Other embodiments include other opening shapes and sizes, such as oval shapes, and shapes that match the features of those portions of the human body being imaged.

The front hemisphere 1a can also have two lateral openings 5. The openings can be both oblong in shape, being elongate along a horizontal axis. Each lateral opening 5 can be associated with a lateral camera 6. The camera 6 can be held by a bracket 7 secured to the support structure 2. Each lateral camera 6 can observe a side of the portion of the human body placed in the opening 4. For example, each camera 6 can observe a side of an individual's face placed in the front opening 4. The two cameras 6 allow the acquisition of a relief image of the portion of the human body, e.g., the individual's face.

FIG. 2 shows the rear hemisphere 1b which can be provided on the inside with a mirror 8 for helping an individual whose head is in the opening 4 to position the face properly therein. The mirror 8 also helps overcome the apprehension which some individuals may feel when inserting their heads into a closed space such as the sphere 1. In the embodiment illustrated, the mirror 8 is not planar, so as to enlarge its field of view.

The rear hemisphere 1b can also be provided on the inside with two spotlamps 9a and 9b which produce crossed light beams, the beams meeting in the plane where it is desired that the user's forehead is to be placed.

FIG. 2 shows that the rear hemisphere 1b can also have a rear opening 10 with a front camera 11 placed behind the opening for the purpose of observing the portion of the human body, e.g. for observing the face from its front. The point where the beams emitted by the lamps 9a and 9b can be situated in the object focal plane of the camera 11.

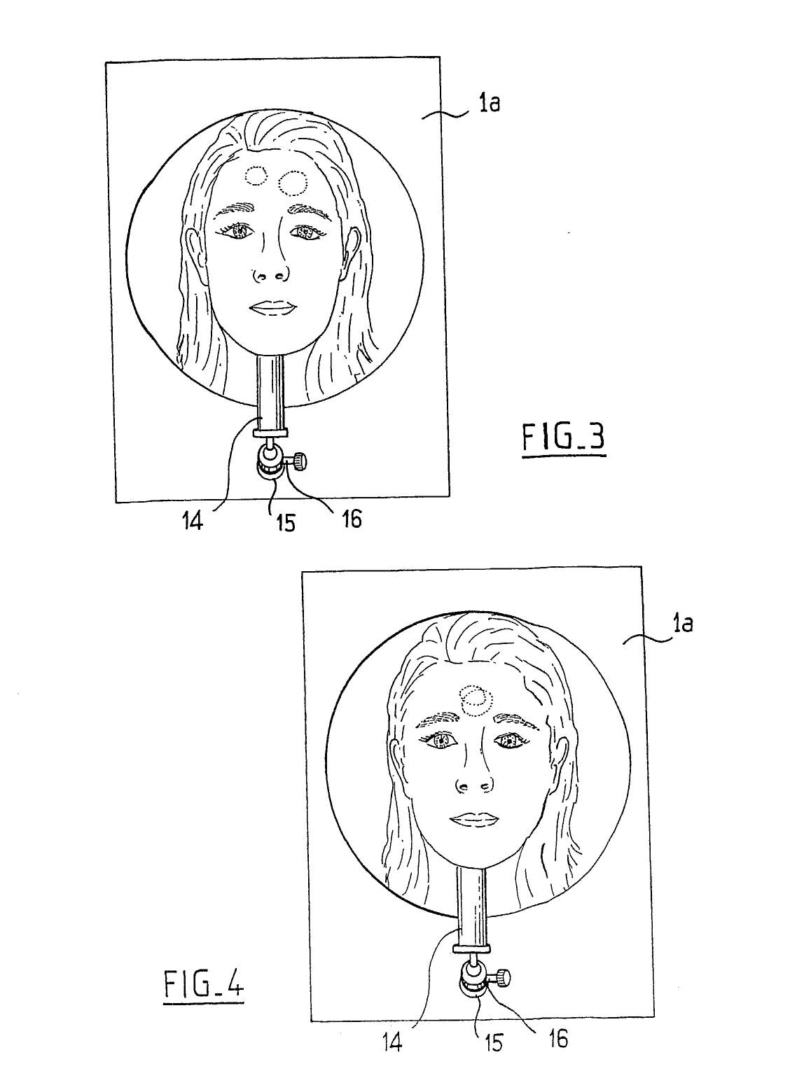

FIG. 3 shows a user whose face is not properly positioned in the opening 4, while FIG. 4 shows the same user in the proper position. FIG. 3 shows that the beams emitted by the lamps 9a and 9b form separate spots on the user's forehead. Once positioning is correct, these spots coincide, as shown in FIG. 4.

The lamps 9a and 9b and the mirror 8 correspond to one example of the positioning device according to the present invention. In the example illustrated, the acquisition device further includes other examples of positioning devices. For example, a support 14 can be secured to the front hemisphere 1a, as shown in FIGS. 3 and 4.

In the example shown, the support 14 includes a tube segment with the top end thereof providing a surface for supporting the portion of the human body, e.g., against which the user can rest her chin. The support 14 can be coupled to the front hemisphere 1a by a coupling element. The coupling element can include a portion 15, which can be secured in a hole in the front hemisphere 1a, and a ball-and-socket connection which can be clamped with a screw 16.

The sphere 1 can be illuminated with light from a light source. As discussed above, the light source can include a plurality of optical fibers connected to a lamp. The lamp can be a xenon lamp or any type of light source, such as a mercury lamp.

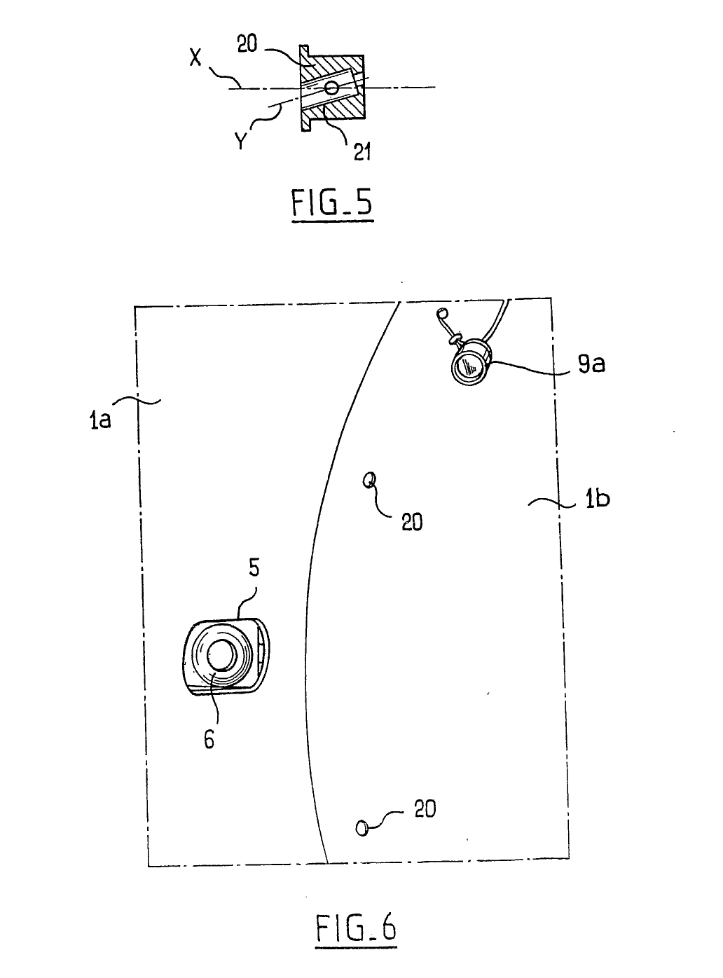

Each optical fiber can be received at one end in an endpiece 20, which is shown in isolation and in diagrammatic axial section in FIG. 5. The endpiece 20 can be swiveled relative to the sphere about its own axis X, and it has a housing 21 to which the optical fibers are fixed. In the illustrated embodiment, the housing 21 has an axis Y which makes an angle of about 15° relative to the axis X. The angle between the axes X and Y can have other values.

The number of endpieces 20 is sufficient to light uniformly the portion of the human body inserted in the opening 4 of the sphere 1. For example, the number of endpieces 20 can be greater than or equal to eight. With uniform lighting, the positioning of the portion of the human body in the opening 4 becomes less critical. In a particular embodiment, the light inside the sphere can comply with Lambert's law.

In the illustrated embodiment, the fibers used can be made of glass. The fibers can have an improved transmission in the blue area of the spectrum.

The color temperature of the light source can be selected, for example, so as to be close to illuminant D65. A light source emitting ultraviolet or infrared radiation can also be used for the present invention. Ultraviolet light can be useful to expose cutaneous photo-aging signs. Infrared light can be useful to provide skin hydration information.

In the embodiment illustrated, the sphere 1 has eight endpieces 20 regularly spaced apart angularly around a ring in a plane close to the equatorial plane of the sphere 1. Because the endpieces 20 can be swiveled about the axes X, it is possible to direct the light emitted by the fibers either toward the rear or toward the front of the sphere 1, so as to obtain the desired lighting. Thus, in order to obtain diffuse lighting, the endpieces 20 can point toward the rear of the sphere. If brilliance is to be observed, the endpieces 20 can be turned about their respective axes X so that the light from the fibers is directly incident on the individual's face. Each fiber illuminates a solid angle corresponding to its numerical aperture. In a non-limiting embodiment, the angle of divergence of the beam emitted by the fiber can be close to 15°.

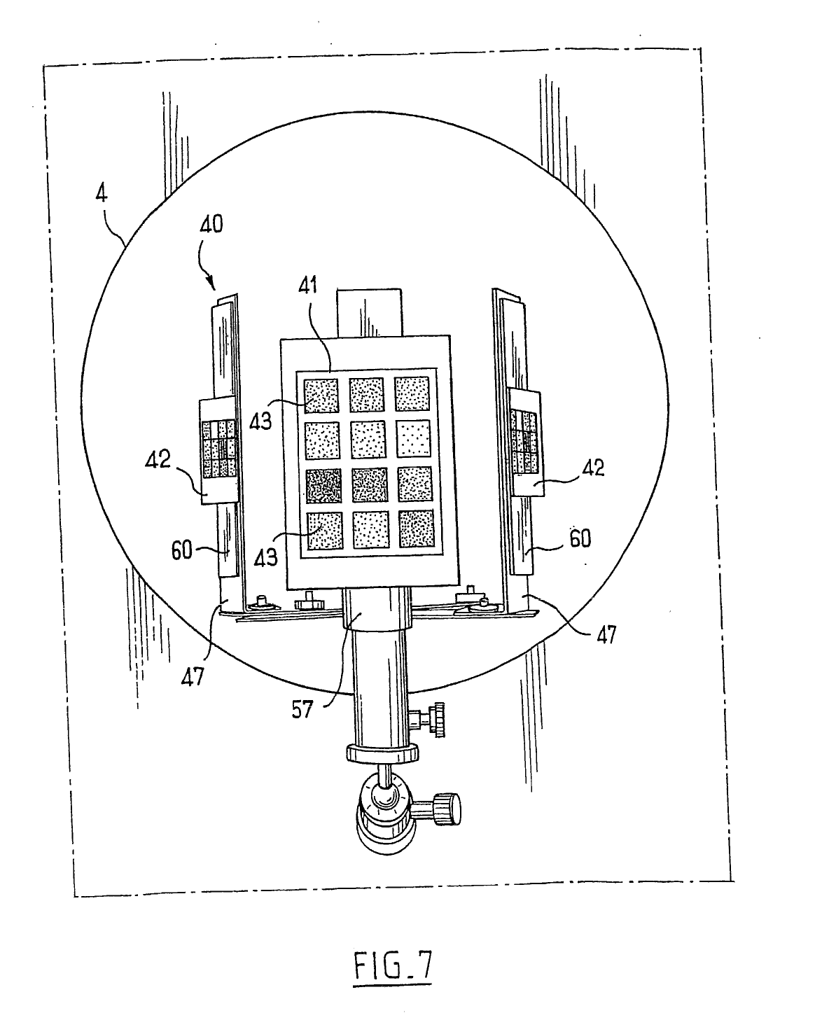

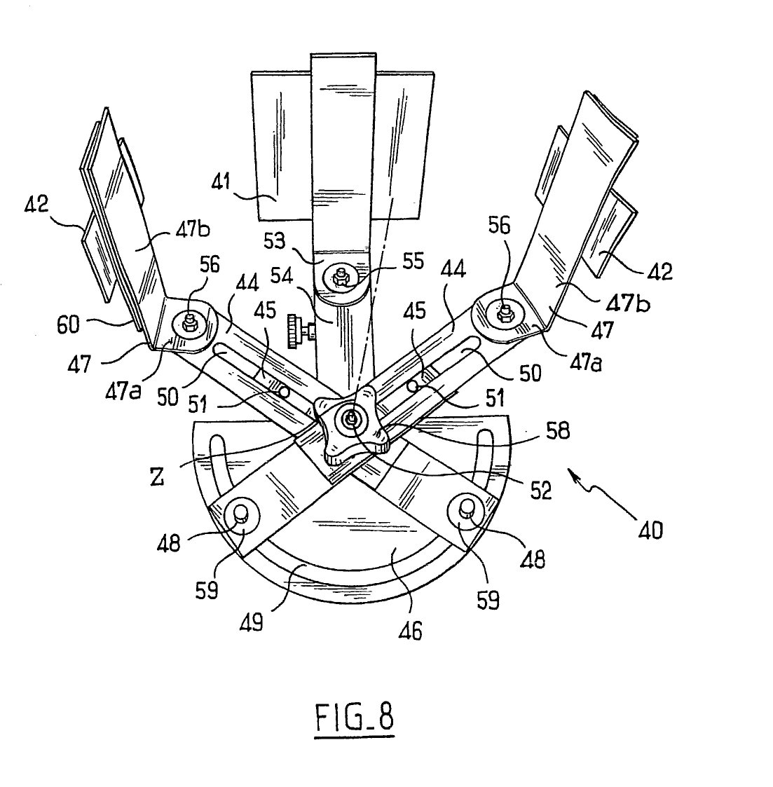

Prior to using the sphere 1 to acquire images of a portion of the human body placed in the opening 4, the cameras 6 and 11 can be calibrated. For this calibration, a calibration triptych 40 can be used, such as the one shown in FIGS. 7 and 8. The triptych 40 includes three calorimetric standards, specifically a central calorimetric standard 41 and two lateral calorimetric standards 42. Each colorimetric standard 41 or 42 includes a plurality of tiles 43 of different colors. In the non-limiting example shown in FIGS. 7 and 8, each colorimetric standard 41 and 42 include twelve tiles.

Each lateral colorimetric standard 42 can be fixed on a support bracket 47 having a base 47a fixed to the end of an arm 44. The arm 44 is slidable on a flat support rod 45 mounted to pivot on a base 46 about a geometrical axis Z. Each rod 45 can be provided at its end remote from the associated colorimetric standard with a screw 48 engaged in a semicircular slot 49, and is retained by a washer 59, as can be seen more clearly in FIG. 8.

Each arm 44 can have an oblong slot 50 in which there slides a stud 51 carried by the flat rod 45. A nut 52 embedded in a handle 58 on the axis Z can lock the arms 44 against sliding over the corresponding flat rods 45 and can lock the assembly in a desired angular orientation about the axis Z of the arms 44. The presence of the slot 49 and of the screws 48 allows the adjustment of the angle between the arms 44 accurately while the nut 52 is loose.

The bottoms 47a of the brackets 47 can be fixed in hinged manner at 56 to the ends of the arms 44. The central standard 41 can be fixed via a hinged connection 55 to a bracket 53 carried by a flat rod 54 secured to the base 46. The rod 54 is secured to a sleeve 57 which enables the base 46 to be fixed to the support 14. The uprights 47b of the brackets 47 can be provided with respective magnetic bars 60 and the calorimetric standards 42 have metal frames which can be coupled magnetically to the bars 60. The same applies to the central calorimetric standard 41. Other coupling mechanisms, such as adhesives and mechanical couplings, can be used to secure the calorimetric standards 42 to the brackets 47.

When the triptych 40 is in place, as shown in FIG. 7, the lateral cameras 6 acquire respective images of the lateral calorimetric standards 42 while the front camera 11 acquires an image of the central colorimetric standard 41. The triptych 40 facilitates the calibration operations because the triptych 40 can simply be placed on the support 14 in order to proceed with the calibration. As mentioned above, a calibration operation similar to the one disclosed in application WO 97/44642 can be used, without having to move the calorimetric standards while calibrating the various cameras.

In the non-limiting example shown in FIG. 7, the calibration device is movable because it is used to calibrate the cameras and then moved out of the enclosure during the image acquisition stage. However, in another embodiment of the present invention, the calibration device can include at least one standard which stays in place on the enclosure after the calibration stage. As an example illustrated in FIG. 9, a calibration device 80 is located inside the enclosure 1 after the initial calibration stage. The calibration device 80 includes, for example, a plurality of surfaces 81 disposed next to each other along a border of the opening 4, in the observation field of the camera(s). The surfaces 81 can correspond respectively to a plurality of gray shades and to different visible light colors. The surfaces 81 can also be adapted to allow a calibration in non-visible light, for example, in the ultraviolet range for example within the wavelength range of 285-400 nm, or in the infrared range for example within the wavelength range of 700-3000 nm. Each surface 81 can have a known spectral reflectance, with the spectral reflectance of at least two surfaces 81 being different. The calibration device 80 can also include, for example, a surface having a known UVA reflectance and another surface having a known UVB reflectance. The calibration device 80 can also be configured to detect fluorescence in a spectral band being different from the spectral band of emission. For example, UVA light can be emitted and a red or orange visible light can be observed. The fluorescence information can be useful to detect a compound or a bacterial presence on the skin surface, for example, a compound or bacterial linked to acne.

In the present invention, the optical fibers can be replaced by other lighting devices, for example by light-emitting diodes fixed to the calibration enclosure. The present invention also includes embodiments with a number of cameras other than three. For example, the acquisition device can include a single front camera. Other picture-taking and position devices can be used. For example, the positioning device can include a telemetry device 70 diagrammatically shown in FIG. 2. Such a telemetry device can have contactless position sensors which are optical, infrared, or ultrasonic. These sensors can be associated with a light or sound indicator 71 for informing and guiding a person positioning their body in the opening 4 of the enclosure 1.

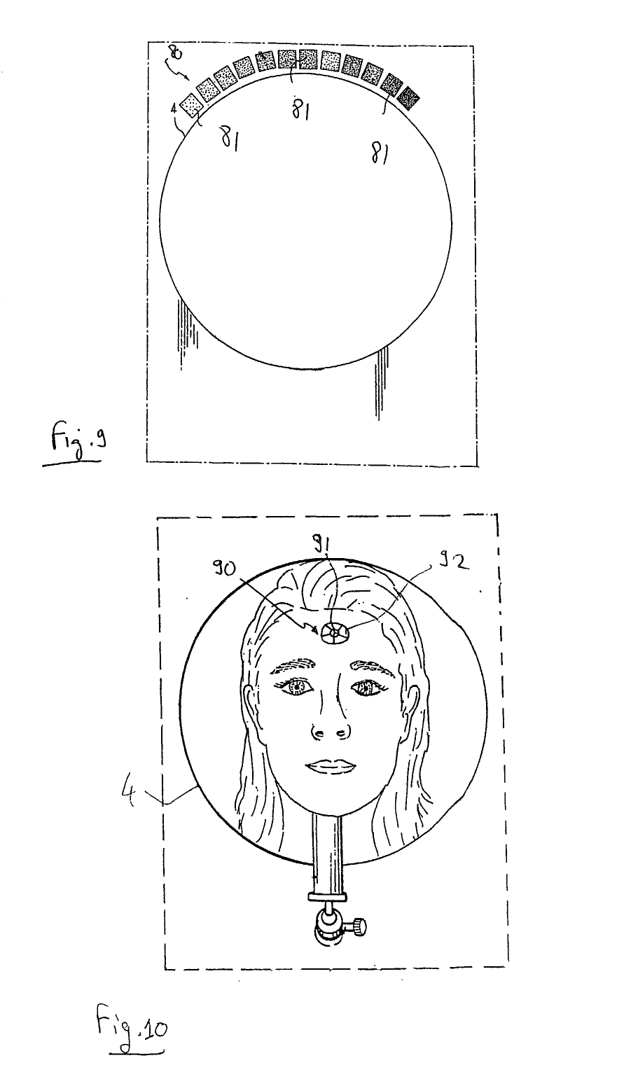

The calibration device of the present invention can also be a detachable device which can be placed on or off the person introducing her face in the enclosure 2. For example, the calibration device can be glued on the forehead of the person. FIG. 10 shows an example of a detachable calibration device 90 including a substrate covered by an adhesive permitting the detachable fixation on the skin, for example, on the forehead of the person who has introduced her head in the opening 4. The calibration device 90 includes, for example, at least three visible surfaces corresponding to different levels of gray and at least two visible surfaces corresponding to two different shades. In this non-limiting example, the calibration device 90 includes a central portion 91 divided in three levels of different gray and a peripheral region 92 including five sectors having different colors.

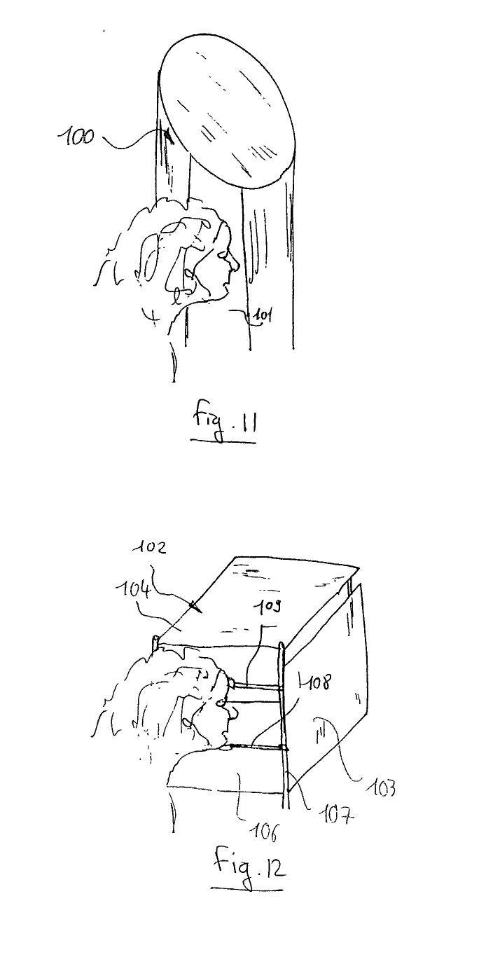

The enclosure 2 can also have a shape other than the one shown in FIG. 1. For example, as shown in FIG. 11, the enclosure 100 can have a cylindrical interior surface having a vertical axis and an opening 101 of rectangular shape. As shown in FIG. 12, an enclosure 102 can also be used with two lateral panels 103, a superior panel 104 and inferior panel 106, as well as a back panel (not shown). The panels need not be joined. If needed, the back panel can be removed to form a dihedron diverging toward the opening with the lateral panels 103. The structure 107 supporting the positioning devices 108 and 109 can be associated or coupled to the enclosure 102. This structure 107 can also support the calibration device.

The information acquired using the present invention can be used to fabricate a make-up product or personalized care product, for example a base having the same color as the individual's skin. In this document, the term “include” is intended to mean “including at least one,” unless otherwise specified.

Obviously, numerous modifications and variations of the present invention are possible in light of the above teachings. It is therefore to be understood that within the scope of the appended claims, the invention can be practiced otherwise than as specifically described therein.

What is claimed as new and desired to be secured by Letters Patent of the United States is:

1. A device for acquiring an image of a portion of the human body, the device comprising:
an enclosure provided with an opening large enough to receive an individual's face,
at least one light source which illuminates the enclosure, and
a colorimetric calibration device which provides colorimetric calibration information for said image.

2. A device according to claim 1, further comprising a positioning device adapted to position said portion of the human body in said opening.

3. A device according to claim 2, wherein said portion of the human body is an individual's face and said positioning device comprises a support adapted to support at least a portion of said face.

4. A device according to claim 3, wherein said support is adapted to support the individual's chin.

5. A device according to claim 2, wherein said positioning device comprises a mirror placed inside the enclosure and positioned so as to reflect an image of said portion of the human body when the portion of the human body is placed in the opening.

6. A device according to claim 5, wherein said mirror is positioned so as to reflect said image toward said opening.

7. A device according to claim 5, wherein said portion of the human body is an individual's face and said mirror is positioned so that said individual can see the individual's face when said face is placed in said opening.

8. A device according to claim 5, wherein said enclosure is a sphere and wherein said mirror is placed above a zone which is diametrically opposite the opening.

9. A device according to claim 5, wherein said mirror has a reflecting surface that is not planar.

10. A device according to claim 2, wherein said positioning device comprises at least two light emitters which generate crossed light beams.

11. A device according to claim 10, wherein said portion of the human body is an individual's face and a point of convergence of said crossed light beams is in a plane where a predetermined portion of the individual's face is to be placed.

12. A device according to claim 11, wherein said predetermined portion is the individual's forehead.

13. A device according to claim 2, wherein said positioning device comprises a telemetry device sensitive to a distance between a predefined point of the portion of the human body and a reference point of known position relative to the enclosure.

14. A device according to claim 2, wherein said positioning device comprises at least one light indicator which is visible from inside the enclosure.

15. A device according to claim 2, wherein said positioning device comprises at least one sound indicator which is audible from inside the enclosure.

16. A device according to claim 15, further comprising a first video camera adapted to observe the portion of the human body substantially along an axis of the opening and a second video camera adapted to observe the portion of the human body substantially from a direction which is at an angle relative to said axis.

17. A device according to claim 16, further comprising a third camera so that said second and third cameras are substantially symmetrically disposed with respect to a plane containing the axis of the opening in order to observe the portion of the human body from directions which that are at an angle with the axis of the opening.

18. A device according to claim 1, further comprising at least two cameras adapted to acquire relief images of said portion of the human body.

19. A device according to claim 1, further comprising a camera with a field of view which includes at least a portion of the opening.

20. A device according to claim 1, wherein said at least one light source is a continuous light source.

21. A device according to claim 1, wherein said at least one light source is a pulsed light source.

22. A device according to claim 1, wherein the calibration device comprises at least five surfaces having different optical properties.

23. A device according to claim 22, wherein at least three of said surfaces correspond to different gray levels and at least two of said surfaces correspond to different shades.

24. A device according to claim 1, further comprising a camera and wherein the calorimetric calibration device comprises a support which holds at least two calorimetric standards in the field of said camera.

25. A device according to claim 24, wherein said support holds three colorimetric standards.

26. A device according to claim 25, wherein two of said colorimetric standards are coupled to a support so as to have an orientation which is modifiable relative to an axis of the opening of the enclosure.

27. A device according to claim 1, further comprising cameras, and wherein the colorimetric calibration device comprises two colorimetric standards, each calorimetric standard being movable toward and away from a camera having a field of view which includes said each colorimetric standard.

28. A device according to claim 27, wherein each colorimetric standard comprises at least twelve color surfaces.

29. A device according to claim 1, wherein the calibration device is removably coupled to said enclosure.

30. A device according to claim 1, wherein the calibration device is permanently fixed to said enclosure.

31. A device according to claim 1, wherein the calibration device is coupled to the portion of the human body.

32. A device according to claim 1, wherein the enclosure is generally spherical in shape.

33. A device according to claim 1, wherein at least a portion of an interior surface of the enclosure is cylindrical.

34. A device according to claim 1, wherein the enclosure includes at least one panel.

35. A device according to claim 34, wherein the enclosure includes at least two lateral panels.

36. A device according to claim 1, wherein the enclosure is made of a thermoformed material.

37. A device according to claim 1, wherein at least a portion of an interior surface of the enclosure is coated with white paint.

38. A device according to claim 37, wherein the white paint is based on titanium oxide.

39. A device according to claim 1, wherein said at least one light source comprises optical fibers.

40. A device according to claim 39, wherein the optical fibers carry light from a xenon source to the enclosure.

41. A device according to claim 1, wherein said at least one light source comprises optical fibers emitting light which directly illuminates an inside surface of the enclosure.

42. A device according to claim 1, wherein the enclosure is free from a diffusion screen placed in front of said at least one light source.

43. A device according to claim 1, wherein the enclosure has at least eight light sources illuminating the inside of the enclosure.

44. A device according to claim 1, wherein said at least one light source is steerable so that said at least one light source directly illuminates the portion of the human body when said at least one light source is steered toward one position and said at least one light source directly illuminates an interior surface of said enclosure when said at least one light source is steered toward another position.

45. A device according to claim 1, wherein the enclosure is free from a cooling fan.

46. A device according to claim 1, wherein the enclosure is generally spherical in shape and wherein the device further comprises a support structure which supports the spherical enclosure along an equatorial region thereof.

47. A device according to claim 1, wherein said at least one light source emits ultraviolet radiation.

48. A device according to claim 1, wherein said at least one light source emits infrared radiation.

49. A method of acquiring an image of a portion of the human body, comprising the steps of:
placing said portion of the human body in an opening of an enclosure, said opening being large enough to receive an individual's face;
calibrating at least one camera by performing with a calibration device one of a colorimetric calibration and a spectral calibration; and
acquiring at least one image of said portion of the human body with said at least one camera.

50. A method as in claim 49, further comprising the step of withdrawing the calibration device before the step of acquiring at least one image.

51. A method of claim 49, further comprising positioning said calibration device on said portion of the human body.

52. A method as in claim 49, wherein said calibration device is left in place during said step of acquiring at least one image.

53. A method according to claim 49, further comprising the step of generating tricromatic components of at least one point in a colorimetric space, other than R, G, B.

54. A method according to claim 49, further comprising analyzing said image so as to detect a skin defect.

55. A method according to claim 49, further comprising irradiating light in a first spectral band; and acquiring an image with said camera in a second spectral band, different from said first spectral band.

56. A method according to claim 49, further comprising illuminating said portion of the human body with a light source.

57. A method according to claim 56, further comprising transporting light from a remote light source to said enclosure with optical fibers and illuminating said portion of the human body with said light.

58. A method according to claim 49, wherein the step of calibrating is performed by performing a calorimetric calibration.

59. A device for acquiring an image of a portion of the human body, the device comprising:
a spherical enclosure provided with an opening large enough to receive the portion of the human body,
a light source which illuminates the enclosure, and
a camera with a field of view which includes at least a portion of the opening.

60. A device according to claim 59, further comprising a positioning device adapted to position said portion of the human body in said opening.

61. A device according to claim 60, wherein said positioning device comprises a mirror placed inside the enclosure and positioned so as to reflect an image of said portion of the human body when the portion of the human body is placed in the opening.

62. A device according to claim 61, wherein said mirror is positioned so as to reflect said image toward said opening.

63. A device according to claim 60, wherein said positioning device comprises at least two light emitters which generate crossed light beams.

64. A device according to claim 60, wherein said positioning device comprises a telemetry device sensitive to a distance between a predefined point of the portion of the human body and a reference point of known position relative to the enclosure.

65. A device according to claim 59, wherein said field of view of said camera is substantially parallel to an axis of the opening.

66. A device according to claim 65, further comprising a second camera with a field of view substantially parallel to a direction which is at an angle relative to said axis of said opening.

67. A device according to claim 66, further comprising a third camera so that said second and third cameras are substantially symmetrically disposed with respect to a plane containing the axis of the opening.

68. A device according to claim 59, wherein said camera is a spectral camera.

69. A device according to claim 59, wherein said light source is remote from said enclosure and further comprising optical fibers which guide light from said light source to said enclosure.

70. A device according to claim 59, wherein said light source comprises a plurality of diodes mounted on an interior surface of said enclosure.

71. A device according to claim 59, further comprising a support coupled to said enclosure.

72. A device according to claim 71, further comprising a positioning device which receives said portion of the human body and which is removably mounted on said support.

73. A device according to claim 71, further comprising a calibration device which is removably mounted on said support.

74. A device according to claim 73, wherein the calibration device comprises a colorimetric standard in the field of view of said camera.

75. A device according to claim 74, wherein said calorimetric standard has an orientation which is modifiable relative to an axis of the opening of the enclosure.

76. A device according to claim 74, wherein said calorimetric standard is movable toward and away from said camera.

77. A device according to claim 59, further comprising a calibration device.

78. A device according to claim 77, wherein said calibration device comprises at least one UV standard.

79. A device for acquiring an image of a portion of the human body, the device comprising:
an enclosure provided with an opening large enough to receive an individual's face,
at least one light source which illuminates the enclosure, and
a spectral calibration device which provides spectral calibration information for said image.

80. A device according to claim 79, further comprising a positioning device adapted to position said portion of the human body in said opening.

81. A device according to claim 80, wherein said portion of the human body is an individual's face and said positioning device comprises a support adapted to support at least a portion of said face.

82. A device according to claim 81, wherein said support is adapted to support the individual's chin.

83. A device according to claim 80, wherein said positioning device comprises a mirror placed inside the enclosure and positioned so as to reflect an image of said portion of the human body when the portion of the human body is placed in the opening.

84. A device according to claim 83, wherein said mirror is positioned so as to reflect said image toward said opening.

85. A device according to claim 83, wherein said portion of the human body is an individual's face and said mirror is positioned so that said individual can see the individual's face when said face is placed in said opening.

86. A device according to claim 83, wherein said enclosure is a sphere and wherein said mirror is placed above a zone which is diametrically opposite the opening.

87. A device according to claim 83, wherein said mirror has a reflecting surface that is not planar.

88. A device according to claim 80, wherein said positioning device comprises at least two light emitters which generate crossed light beams.

89. A device according to claim 88, wherein said portion of the human body is an individual's face and a point of convergence of said crossed light beams is in a plane where a predetermined portion of the individual's face is to be placed.

90. A device according to claim 89, wherein said predetermined portion is the individual's forehead.

91. A device according to claim 80, wherein said positioning device comprises a telemetry device sensitive to a distance between a predefined point of the portion of the human body and a reference point of known position relative to the enclosure.

92. A device according to claim 80, wherein said positioning device comprises at least one light indicator which is visible from inside the enclosure.

93. A device according to claim 80, wherein said positioning device comprises at least one sound indicator which is audible from inside the enclosure.

94. A device according to claim 93, further comprising a first video camera adapted to observe the portion of the human body substantially along an axis of the opening and a second video camera adapted to observe the portion of the human body substantially from a direction which is at an angle relative to said axis.

95. A device according to claim 94, further comprising a third camera so that said second and third cameras are substantially symmetrically disposed with respect to a plane containing the axis of the opening in order to observe the portion of the human body from directions which that are at an angle with the axis of the opening.

96. A device according to claim 79, further comprising at least two cameras adapted to acquire relief images of said portion of the human body.

97. A device according to claim 79, further comprising a spectral camera with a field of view which includes at least a portion of the opening.

98. A device according to claim 79, wherein said at least one light source is a continuous light source.

99. A device according to claim 79, wherein said at least one light source is a pulsed light source.

100. A device according to claim 79, wherein the calibration device comprises at least five surfaces having different optical properties.

101. A device according to claim 79, wherein said spectral calibration device comprises at least one UV standard.

102. A device according to claim 79, further comprising a camera and wherein the spectral calibration device comprises a support which holds at least two spectral standards in the field of said camera.

103. A device according to claim 102, wherein said support holds three spectral standards.

104. A device according to claim 103, wherein two of said spectral standards are coupled to a support so as to have an orientation which is modifiable relative to an axis of the opening of the enclosure.

105. A device according to claim 79, further comprising cameras, and wherein the spectral calibration device comprises two spectral standards, each spectral standard being movable toward and away from a camera having a field of view which includes said each spectral standard.

106. A device according to claim 105, wherein each spectral standard comprises at least twelve color surfaces.

107. A device according to claim 79, wherein the calibration device is removably coupled to said enclosure.

108. A device according to claim 79, wherein the calibration device is permanently fixed to said enclosure.

109. A device according to claim 79, wherein the calibration device is coupled to the portion of the human body.

110. A device according to claim 79, wherein the enclosure is generally spherical in shape.

111. A device according to claim 79, wherein at least a portion of an interior surface of the enclosure is cylindrical.

112. A device according to claim 79, wherein the enclosure includes at least one panel.

113. A device according to claim 112, wherein the enclosure includes at least two lateral panels.

114. A device according to claim 79, wherein the enclosure is made of a thermoformed material.

115. A device according to claim 79, wherein at least a portion of an interior surface of the enclosure is coated with white paint.

116. A device according to claim 115, wherein the white paint is based on titanium oxide.

117. A device according to claim 79, wherein said at least one light source comprises optical fibers.

118. A device according to claim 117, wherein the optical fibers carry light from a xenon source to the enclosure.

119. A device according to claim 79, wherein said at least one light source comprises optical fibers emitting light which directly illuminates an inside surface of the enclosure.

120. A device according to claim 79, wherein the enclosure is free from a diffusion screen placed in front of said at least one light source.

121. A device according to claim 79, wherein the enclosure has at least eight light sources illuminating the inside of the enclosure.

122. A device according to claim 79, wherein said at least one light source is steerable so that said at least one light source directly illuminates the portion of the human body when said at least one light source is steered toward one position and said at least one light source directly illuminates an interior surface of said enclosure when said at least one light source is steered toward another position.

123. A device according to claim 79, wherein the enclosure is free from a cooling fan.

124. A device according to claim 79, wherein the enclosure is generally spherical in shape and wherein the device further comprises a support structure which supports the spherical enclosure along an equatorial region thereof.

125. A device according to claim 79, wherein said at least one light source emits ultraviolet radiation.

126. A device according to claim 79, wherein said at least one light source emits infrared radiation.
